(19) United States
(12) Patent Application Publication
(10) Pub. No.: US 2025/0242194 A1
(43) Pub. Date: Jul. 31, 2025

(54) VARIABLE HEIGHT WEIGHTLIFTING PLATFORM SYSTEM

(71) Applicant: HydraBlocks LLC, Henderson, NV (US)

(72) Inventor: Michael Robert Beauchamp, JR., Henderson, NV (US)

(21) Appl. No.: 19/040,598

(22) Filed: Jan. 29, 2025

Related U.S. Application Data
(60) Provisional application No. 63/626,410, filed on Jan. 29, 2024.

(51) Int. Cl. A63B 21/00; A63B 21/072; A63B 71/00; F15B 15/14

(52) U.S. Cl. CPC A63B 21/4033; A63B 21/0724; A63B 71/0036; F15B 15/14; A63B 2071/0063; A63B 2208/0204; A63B 2225/093

(57) ABSTRACT

The present disclosure provides a weightlifting system that includes elevating platforms, each being configured to support opposing ends of a barbell; and hydraulic mechanisms coupled to the elevating platforms, respectively, and configured to move the elevating platforms in a vertical direction between a first position and a second position to raise and lower the barbell, wherein each of the elevating platforms comprises: a shock rubber layer, one or more plywood layers positioned below the shock rubber layer, a shock plate positioned below the one or more plywood layers, the shock plate configured to distribute, equally to a plurality of energy attenuating isolators arranged below the shock plate, forces applied to the elevating platform when contacted by the barbell, and a shock plate frame positioned between the shock plate and the plurality of isolators, the shock plate frame configured to support and prevent deformation of the shock plate.

### CROSS-REFERENCE TO RELATED APPLICATIONS

This application claims the benefit, and priority benefit, of U.S. Provisional Patent Application Ser. No. 63/626,410, filed Jan. 29, 2024, titled “VARIABLE HEIGHT WEIGHTLIFTING PLATFORM SYSTEM,” the disclosure of which is incorporated by reference herein in its entirety.

### FIELD

The present disclosure generally relates to a variable height weightlifting platform system and methods of use thereof.

### BACKGROUND

Typically, a weight rack is a sturdy and often compact piece of fitness equipment designed to organize, store, and provide easy access to various type of weights. The primary function of a traditional weight rack is to provide organization to a space by minimizing clutter and maximizing floor space and designed to securely weights to prevent accidents. Also, another function of the weigh rack is to safely store a barbell, where a major cause of injuries that occur in a weight room are caused by dangerously dropping a barbell that bounces off a floor into an individual. In addition, a traditional feature of a common weight rack is static barbell holders at predetermined notches, where these static holders may be bulky and can be considered a hassle to manipulate between activities.

### SUMMARY OF DESCRIBED SUBJECT MATTER

In some embodiments, the present disclosure provides an exemplary technically improved weightlifting system, including: first and second elevating platforms, each being configured to support first and second opposing ends of a barbell, respectively; and first and second hydraulic mechanisms coupled to the first and second elevating platforms, respectively, and configured to move the elevating platforms in a vertical direction between a first position and a second position to raise and lower the barbell, where each of the first and second elevating platforms includes: a shock rubber layer, one or more plywood layers positioned below the shock rubber layer, a shock plate positioned below the one or more plywood layers, the shock plate configured to distribute, equally to a plurality of energy attenuating isolators arranged below the shock plate, forces applied to the elevating platform when contacted by the barbell, and a shock plate frame positioned between the shock plate and the plurality of isolators, the shock plate frame configured to support and prevent deformation of the shock plate.

In some embodiments, the exemplary technically improved weightlifting system may further include a static platform positioned between the first and second elevating platforms and configured to support a user of the barbell.

In some embodiments, the shock rubber layer may include a recycled rubber material having an upper surface that is sufficiently abrasion resistant to withstand impacts from the barbell and a high coefficient of friction for deterring movement of the barbell on the upper surface.

In some embodiments, the one or more plywood layers may include an upper layer and a lower level of urethane-coated plywood material.

In some embodiments, the shock plate may be made of a metal material.

In some embodiments, the at least one of the plurality of energy attenuating isolators may include a sorbothane material.

In some embodiments, the at least one energy attenuating isolator including the sorbothane material may have a cylindrical shape.

In some embodiments, the at least one energy attenuating isolator including the sorbothane material may be configured to maintain a consistent shape factor, material mass, and predictable displacement in response to an impact of the barbell with the elevating platforms, where the barbell weighs between about 35 pounds and about 1000 pounds and may be dropped from heights ranging between about 0 inches above the elevating platforms to about 80 inches above the elevating platforms.

In some embodiments, the at least one energy attenuating isolator including the sorbothane material may have a hardness of about 70 duro, and where the elevating platforms attenuate energy associated with the impact to maximum gravitational forces equivalent of about 2.5 Gs and about 6 Gs for impacts consistent with a mass being dropped from about 60 inches and weighing about 170 pounds and about 80 pounds, respectively.

In some embodiments, the at least one energy attenuating isolator including the sorbothane material may have a hardness of about 50 duro, and where the elevating platforms attenuate energy associated with the impact to maximum gravitational forces equivalent of about 2 Gs and about 1.2 Gs for impacts consistent with a mass being dropped from about 60 inches and weighing about 170 pounds and about 80 pounds, respectively.

In some embodiments, the first and second hydraulic mechanisms may each include one or more direct drive hydraulic cylinders capable of automatically raising or lowering the elevating platforms between the first position and the second position.

In some embodiments, the first position may be even with a surface on which a user is supported when using the system and the second position is above the first position.

In some embodiments, the present disclosure provides an exemplary technically improved energy attenuating system, including: a first layer comprising recycled rubber having a thickness of about 0.5 inches; a second layer and a third layer, each comprising plywood having a thickness of about 0.75 inches; a fourth layer comprising a steel plate having a thickness of about 0.25 inches; and a fifth layer comprising a plurality of deformable members, each deformable member comprising a sorbothane material.

In some embodiments, the first layer may have a thickness of about 0.5 inches.

In some embodiments, the second and third layers may each have a thickness of about 0.75 inches.

In some embodiments, the fourth layer may have a thickness of about 0.25 inches.

In some embodiments, the plurality of deformable members may have a hardness of between about 50 duro and 70 duro.

In some embodiments, the plurality of deformable members may have a shape factor of between about 0.3 and about 1.0.

In some embodiments, the plurality of deformable members may have a cylindrical shape with a diameter of about 1.5 inches to about 1.7 inches, and a height of about 1.5 inches.

In some embodiments, the present disclosure provides an exemplary weightlifting system, including: a platform, including: first and second elevating platform portions, each being configured to support first and second opposing ends of a barbell, respectively; one or more static platform portions, at least one of which is positioned between the first and second elevating platform portions and configured to support a user of the barbell; and first and second hydraulic mechanisms coupled to the first and second elevating platform portions, respectively, and configured to move the elevating platform portions in a vertical direction between a first position substantially even with, and a second position above, the at least one static portion positioned between the first and second elevating platform sections to raise and lower the barbell.

### BRIEF DESCRIPTION OF DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts a block diagram of an exemplary variable weightlifting platform system, in accordance with one or more embodiments of the present disclosure.

FIG. 2 depicts an alternate view of an exemplary variable weightlifting platform system, in accordance with one or more embodiments of the present disclosure.

FIG. 3 depicts an exemplary variable weightlifting platform system without a full platform, in accordance with one or more embodiments of the present disclosure.

FIG. 4 depicts a cross-sectional view of an exemplary variable weightlifting platform system, in accordance with one or more embodiments of the present disclosure.

FIG. 5 depicts results of a weight drop test with no isolator, in accordance with one or more embodiments of the present disclosure.

FIG. 6 depicts results of a weight drop test of 170 lbs. at a predetermined height utilizing a 70-durometer isolator, in accordance with one or more embodiments of the present disclosure.

FIG. 7 depicts results of a weight drop test of 80 lbs. at a predetermined height utilizing a 70-durometer isolator, in accordance with one or more embodiments of the present disclosure.

FIG. 8 depicts results of a weight drop test of 170 lbs. at a predetermined height utilizing a 50-durometer isolator, in accordance with one or more embodiments of the present disclosure.

FIG. 9 depicts results of a weight drop test of 80 lbs. at a predetermined height utilizing a 50-durometer isolator, in accordance with one or more embodiments of the present disclosure.

FIG. 10 depicts a comparison of the results from a plurality of weight drop tests of varying weights at a predetermined height utilizing a varying isolator, in accordance with one or more embodiments of the present disclosure.

FIG. 11 depicts an exemplary sorbothane isolator associated with a variable weightlifting platform system, in accordance with one or more embodiments of the present disclosure.

FIG. 12 is an exploded view of at least one shock block associated with a variable weightlifting platform system, in accordance with one or more embodiments of the present disclosure.

FIG. 13 is an exploded view of an exemplary Hydrablock associated with a variable weightlifting platform system, in accordance with one or more embodiments of the present disclosure.

FIG. 14 depicts a drop test apparatus associated with an exemplary variable weightlifting platform system, in accordance with one or more embodiments of the present disclosure.

FIG. 15 depicts a deflection result related to an exemplary sorbothane isolator associated with a variable weightlifting platform system, in accordance with one or more embodiments of the present disclosure.

FIG. 16 depicts results of a drop test of 135 lbs. at a height of 85 inches utilizing an exemplary sorbothane isolator, in accordance with one or more embodiments of the present disclosure.

FIG. 17 depicts results of a drop test of 135 lbs. at a height of 77 inches utilizing an exemplary sorbothane isolator, in accordance with one or more embodiments of the present disclosure.

FIG. 18 depicts output variables related to power utilizing an exemplary sorbothane isolator, in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

The present disclosure describes, in detail, systems and methods of automatically adjusting a height associated with a plurality of weights via a platform and one or more hydraulic lifts. The following embodiments provide technical solutions and technical improvements that overcome technical problems, drawbacks and/or deficiencies in the technical fields involving weight support, weight height adjustment, and shock attenuation. Such technical fields often operate within resource constraints, including limitations on weight support limitations and shock attenuation limitations. Specifically, a technological problem exists in attempting to manually adjust a height associated with a particular amount of weight, as this may become dangerous to a user and to the weights. Typically, the manual adjustment of weights without adequate shock attenuation may result in damage to an environment where the weights are located and/or damage to the weights themselves. Moreover, typical common jerk blocks are made from a pure plywood construction and use vertical orientation for strength and then multiple sheets for impact resistance. Although these typical common jerk blocks may be acceptable for use, the shock attenuation associated with the common jerk block remains far too low for a common commercial setting. As explained in more detail below, technical solutions and technical improvements herein include aspects of improved technologies for automatically adjusting the height of a plurality of weights via a hydraulic platform system, which provide additional protection to a hydraulic system, additional to a user utilizing the hydraulic platform system, and additional exercise flexibility. In some embodiments, the additional exercise flexibility may refer to an ability of the user to perform a plurality of exercises that may be considered dangerous with a traditional weightlifting platform system, thereby increasing safety associated with the automatic adjustment of a height of a plurality of weights. In certain embodiments, the hydraulic platform system may include one or more direct drive hydraulic cylinders to raise or lower elevating portions of the platform. Moreover, various practical applications of the disclosed technology are also described, which provide further practical benefits to users and operators that are also new and useful improvements in the art.

### Representative Embodiment & Summary

HydraBlocks is a fully automatic, variable height, weightlifting platform system. HydraBlocks, in various embodiments, may feature two variable height shock platforms and four stationary shock platforms. Its overall dimensions are 12′ cubed. HydraBlocks also features fully automatic controls for raising and lowering the platforms. Finally, HydraBlocks features an automatic mechanical rachet safety system. In certain embodiments, HydraBlocks may refer to an exemplary variable weightlifting platform system.

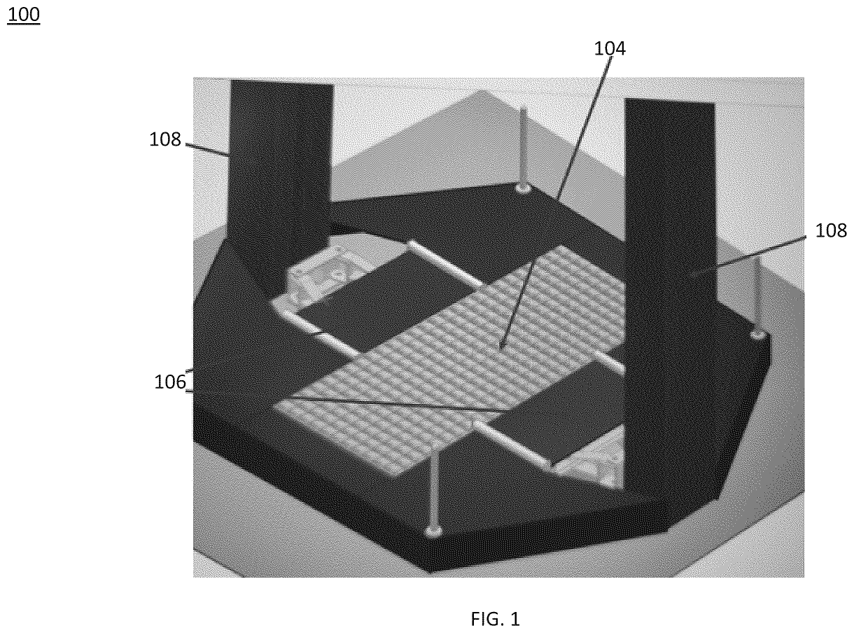

FIG. 1 depicts a block diagram 100 of an exemplary variable weightlifting platform system, in accordance with one or more embodiments of the present disclosure.

In some embodiments, the exemplary variable weightlifting platform system 102 may include a platform 104, at least two elevating platforms 106 coupled to each side of the platform 104, and at least two hydraulic mechanisms 108 capable of controlling the at least two elevating platforms 106. In certain embodiments, the platform 104 may refer to a static platform, where a person would stand during one or more activities.

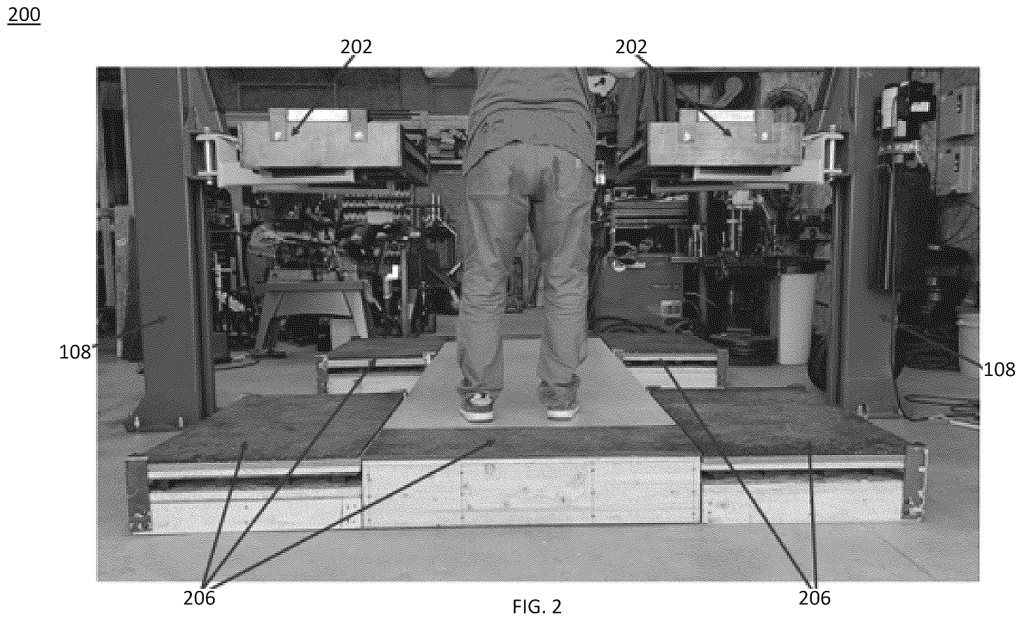

FIG. 2 depicts an alternate view 200 of an exemplary variable weightlifting platform system 102, in accordance with one or more embodiments of the present disclosure.

In some embodiments, the at least two elevating platforms 106 may be raised to a preferred height via the at least two hydraulic mechanisms 108 above the platform 104. In certain embodiments, the height may range from a minimum of one inch to a maximum of eight feet. In some embodiments, HydraBlocks may utilize two direct drive hydraulic cylinders to raise or lower elevating platforms 106 of the platform 104. This may maximize the height range of the system. Direct drive also is the safest for the user, as it eliminates shear points due to scissor arms or levers. In a preferred embodiment, HydraBlocks boasts a height range of zero to a of a maximum 66″ as a result of direct drive hydraulic mechanisms 108. In certain embodiments, the hydraulic platform system 102 may include two variable height shock platforms 202 and four stationary shock platforms 204. In some embodiments, each portion of the plurality of portions may maintain an overall dimension of a height of sixteen inches, width of sixteen inches, and a length of sixteen inches (e.g., sixteen inches cubed). In certain embodiments, each portion may maintain a preferred overall dimension of twelve inches cubed.

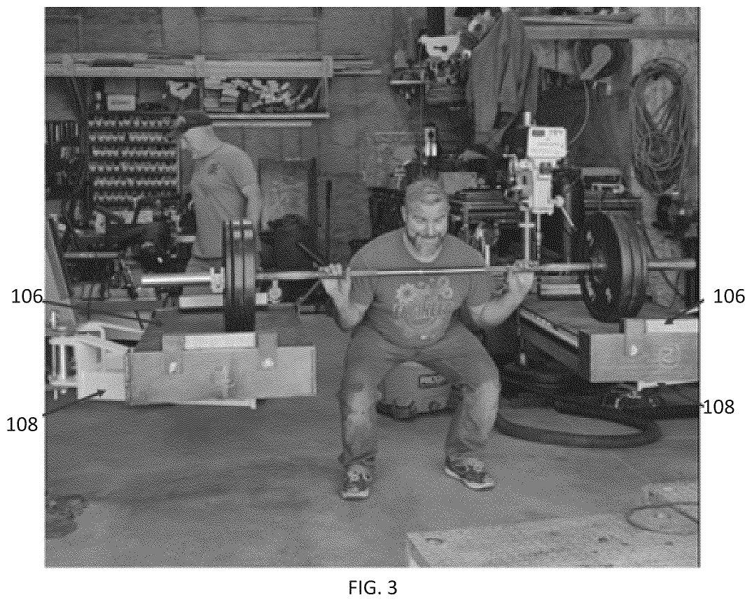

FIG. 3 depicts an exemplary variable weightlifting platform system 102 without a full platform, in accordance with one or more embodiments of the present disclosure.

In some embodiments, the at least two elevating platforms 106 may be placed over an area that is not the platform 104. In certain embodiments, the elevating platforms 106 being raised via the hydraulic mechanisms 108 may provide free weight support for one or more activities when placed over an area that is not the platform 104. In some embodiments, the variable weightlifting platform system 102 may be capable moving from a first location to a second location, making the system mobile.

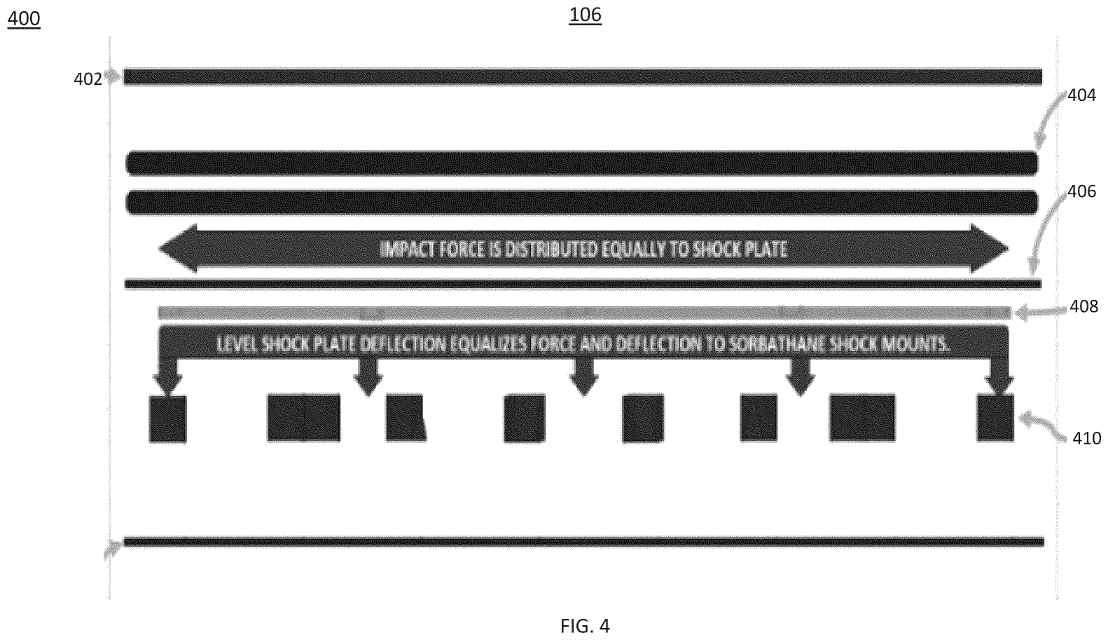

FIG. 4 depicts a cross-sectional view 400 of at least one elevating platform 106 of an exemplary variable weightlifting platform system 102, in accordance with one or more embodiments of the present disclosure.

In some embodiments, the at least one elevating platform 106 may include an exemplary shock system 401. In some embodiments, the exemplary shock system 401 may include a top layer 402 of shock rubber, an upper and lower levels of plywood 404, a shock plate 406, a shock plate frame 408, and an arrangement of a plurality of energy attenuating isolators 410. In certain embodiments, the top layer of shock rubber 402 may refer to recycled rubber as an optimal surface for abrasion resistance and a high coefficient of friction. In certain embodiments, the upper and lower levels of plywood 404 may refer to a urethane coated plywood to reduce decibel level on impact and initiates distribution of the impact force. For example, the upper and lower levels of plywood 404 may protect the shock plate 406 from deformation and ensures permanent integrity. In certain embodiments, the shock plate 406 may distribute all for forces equally to the plurality of energy attenuating isolators 410 and may ensure the shock system 401 remains level under impact. For example, the shock plate 406 may be critical for proper sorbothane deflection as too much deflection on a particular sorbothane cylinder may erode the durability of the plurality of energy attenuating isolators 410. In certain embodiments, the shock plate frame 408 may protect the shock plate 406 from deformation to ensure a permanently level shock system 401. For example, the shock plate frame 408 allows for maximum shock absorption and predictable rebound path, which optimizes safety for a user. In certain embodiments, the arrangement of a plurality of energy attenuating isolators 410 may absorb the entire range of forces possible during impacts regardless of a height or weight load (i.e., 0-80 inches, 35-1000 lbs.) In addition, the combination of durometer, shape factor, and mass may tune the deflection to a preferred displacement. For example, the arrangement of a plurality of energy attenuating isolators 410 may perform one million cycles of use for each energy attenuating isolator, which would extend the life of the shock system 401. Any other arrangement or material combination would be practically impossible in a commercial service setting as a result of drop testing (described below) due to material fatigue and maintenance. HydraBlocks largest asset is its proprietary shock attenuation system 401. This system is critical for 3 main reasons:

1—Hydraulic System Protection—For hydraulic system longevity and reliability, the direct drive cylinders must have any shock mitigated. This allows the platforms to be used at heights not directly engaged with the mechanical safeties, and thus obtain a non-incremental height system.

2—User Safety—With a reduction in shock energy of up to 92.5%, the user can enjoy a much safer environment. All barbell rebound is virtually eliminated protecting the user from any random barbell impact.

3—Exercise Usability—The comfort level of using HydraBlocks is unmatched. Because of the shock mitigation, any ‘touch n go’ or multiple repetitions are much easier to control. The user does not have to reindex foot position, as all impact variance is mitigated allowing them to focus on the quality of the lift. This gives the user a ‘smith machine’ feeling or the feeling of the bar being on a track or rail.

After extensive research and testing, a material called Sorbothane was chosen as an isolator. This material has a proven track record with vibration and shock attenuation. The challenge was to achieve both maximum dampening performance and cycles.

### Best Practices for Deflection

The most effective static deflection for Sorbothane with a shape factor between 0.3 and 1.0 is in the range of 10-20%. The term “shape factor” as used herein refers to the ratio of the loaded area to unloaded area of an isolator. For shape factors less than 1.2 and percent dynamic deflections less than 40% the expected fatigue life is considered to be in excess of one million cycles (indefinite). For Shape Factors less than 1.2 and percent dynamic deflections between 40% and 60% the expected fatigue life is considered to be in excess of 1,000 cycles. The percent static deflection (continuous load without impact) must not exceed 20%. There is no accepted methodology for higher shape factors or higher percent dynamic deflections.

The first step was engineering a system with a static deflection range of 10-20% to ensure system longevity in a commercial environment. It was quickly realized that many isolators would be used as the shock plate is a very large area (L43″×W24.25″). This was also to guarantee a level impact surface under static and dynamic forces. Thirty-two isolators in a configuration of 4×8 was ultimately chosen.

### Drop Testing Summary

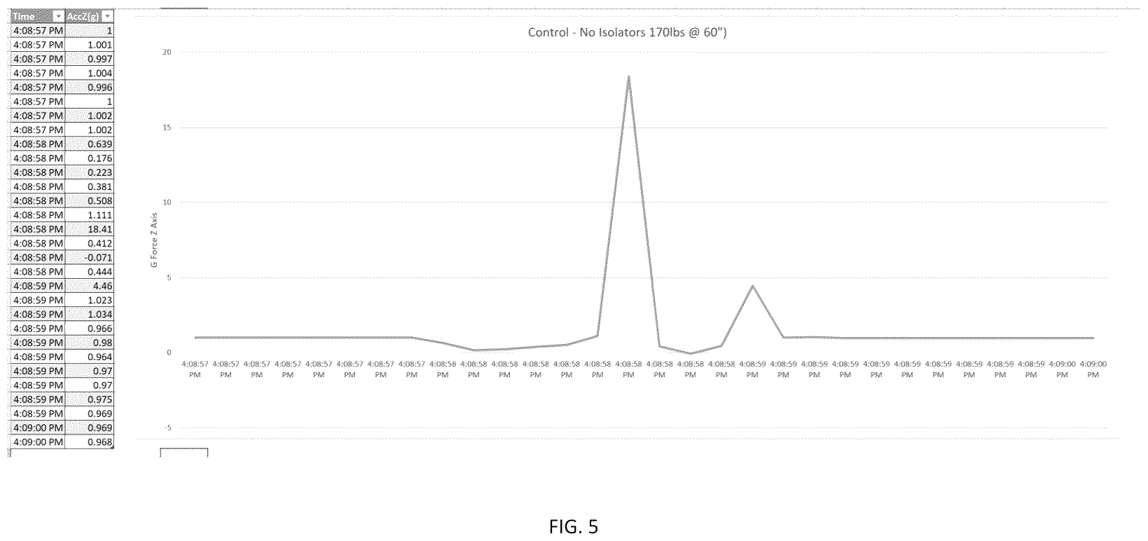

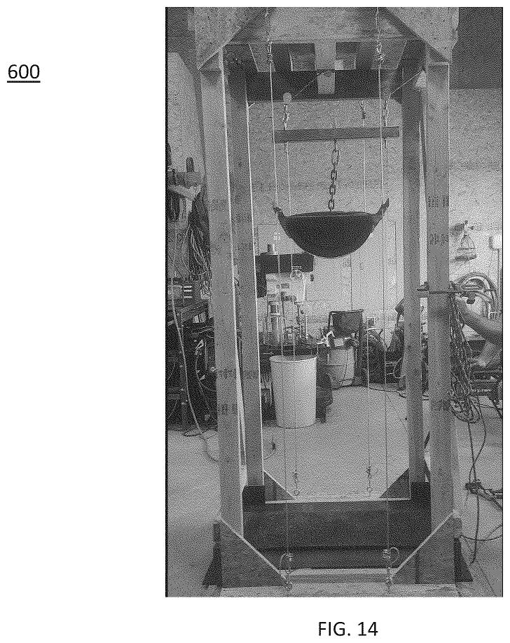

A custom drop test apparatus 600 (FIG. 14) was employed to explore the shock attenuation of the Sorbothane. A bumper weight plate was modified into a test platen that can be loaded with additional mass. The platen was fitted with a triaxial accelerometer. A 170 lb plate was used to mimic a 350 lb barbell. This platen mass, at a drop height of 60″, would be the highest forces the system would see in a typical commercial environment. All tests we performed using a 60″ drop height to ensure worst case environment. The results of these test are depicted as FIGS. 5-10.

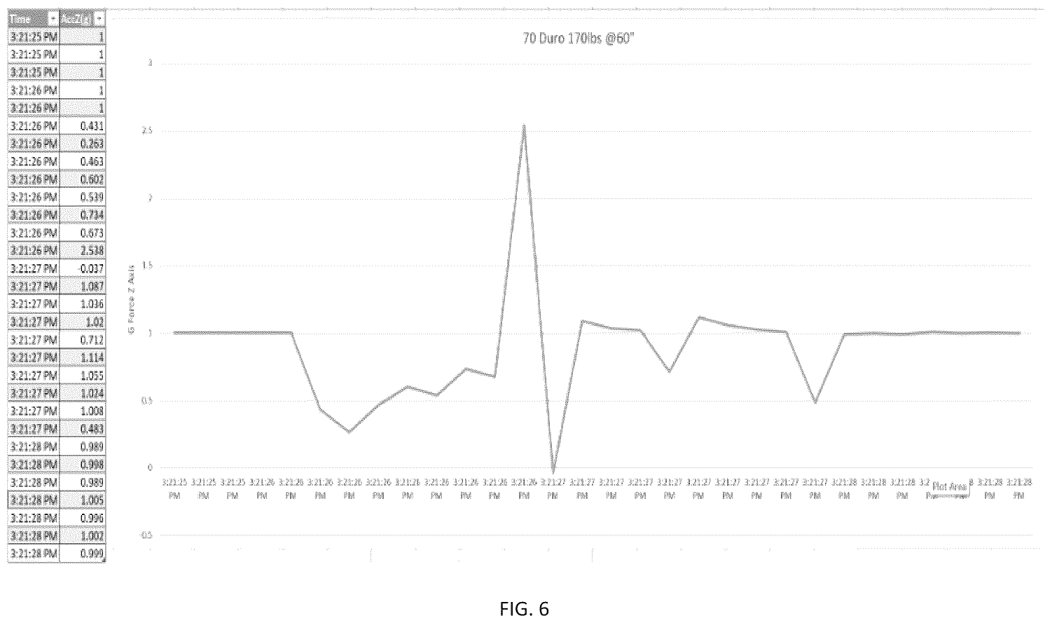

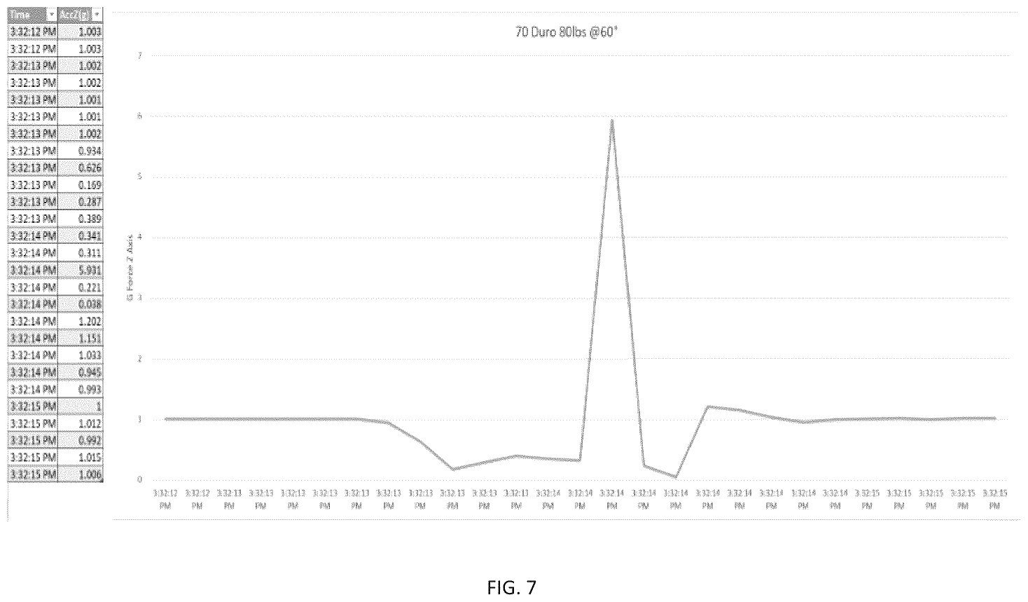

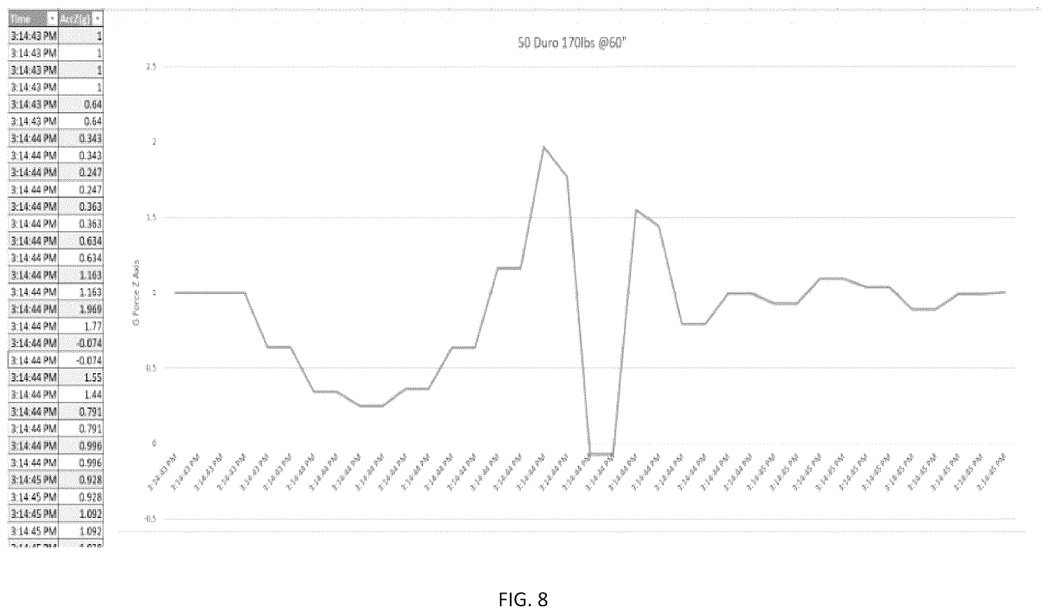

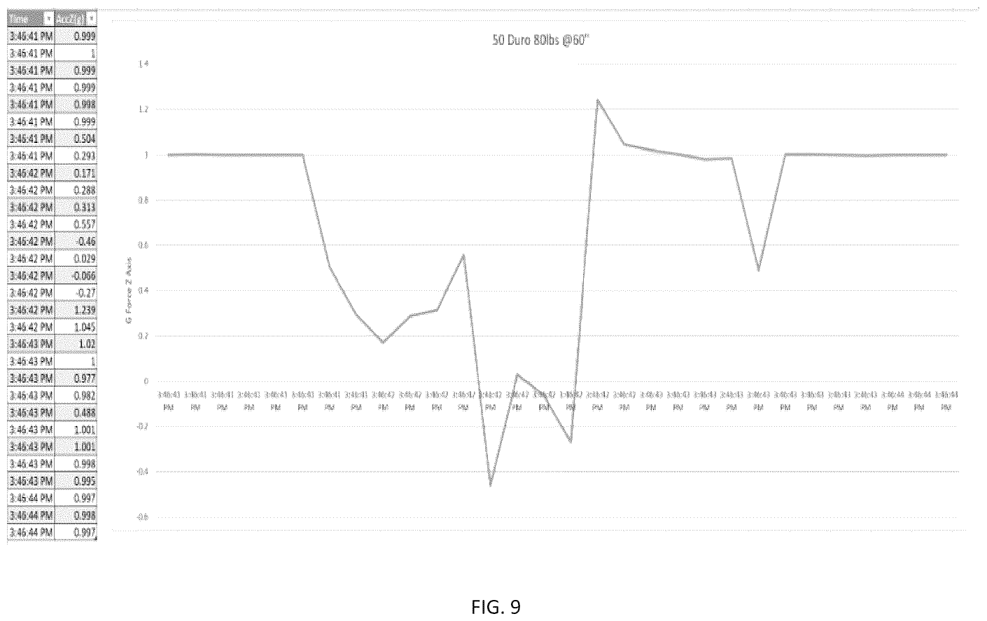

5 different conditions were tested:
Control—No Isolators (FIG. 5)·
70 Durometer—32 Qty—1.5″ Cubes—170 lbs (FIG. 6)·
70 Durometer—32 Qty—1.5″ Cubes—80 lbs (FIG. 7)·
50 Durometer—32 Qty—1.5″ Cubes—170 lbs (FIG. 8)·
50 Durometer—32 Qty—1.5″ Cubes—170 lbs (FIG. 9)

In each test, at least two parameters were considered: impact g-force and impact deflection. Impact g-force ultimately pertains to how much force the hydraulic system would be exposed to.

Based on platform height and proper deflection displacement, a 1.5″ isolator height was chosen. In exploring proper static deflection, the 30-durometer test isolators failed to meet the 10-20% range requirement. The mass of the shock plate and additional impact layers of material were simply too much mass for this durometer.

With the 30-durometer eliminated from consideration, the 70-durometer was tested. Shock attenuation for high loads was adequate. However, at lower loads (80 lbs-155 lbs) shock attenuation eroded. This was due to the higher durometer transmitting the shock energy due to a lack of static and dynamic deflection.

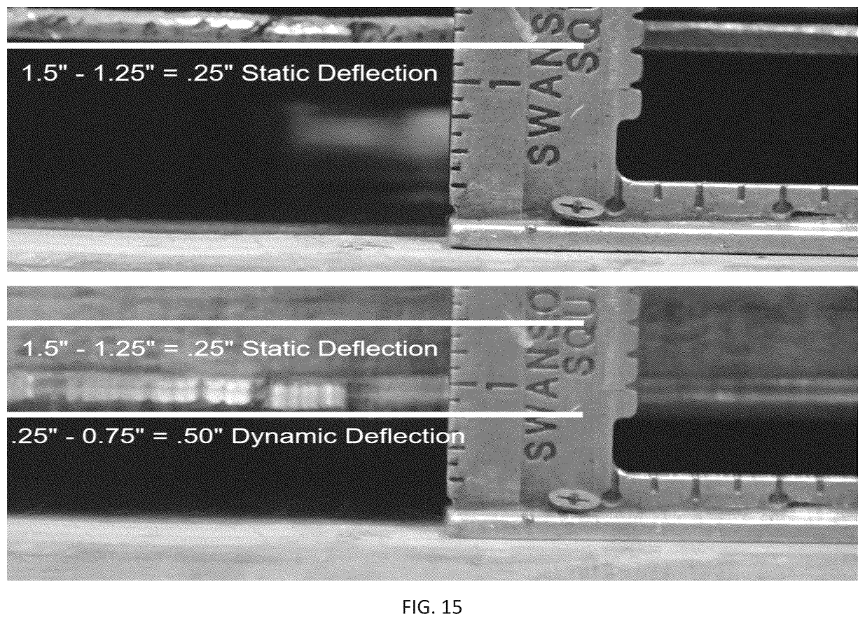

Fortunately, the 50-durometer met all three criteria: static deflection, dynamic deflection, and shock attenuation at all applicable loads. The 50-durometer yielded a static deflection of 0.25″ (16.67%). The highest test loads yielded an impact deflection of 0.5″ (33.33% deflection). (FIG. 15)

50-Durometer Deflection

| | | Displacement | Isolator | |
|---|---|---|---|---|
| Status | Displacement | % | Height | Height % |
| No Load | 0″ | 0 | 1.5″ | 0 |
| Top Plate Added | 0.25″ | 16.67% | 1.25″ | 83.33% |
| Max Impact | 0.5″ | 33.33% | 1″ | 66.67% |
| Total Deflection | 0.75″ | 50.00% | 0.75″ | 50.00% |

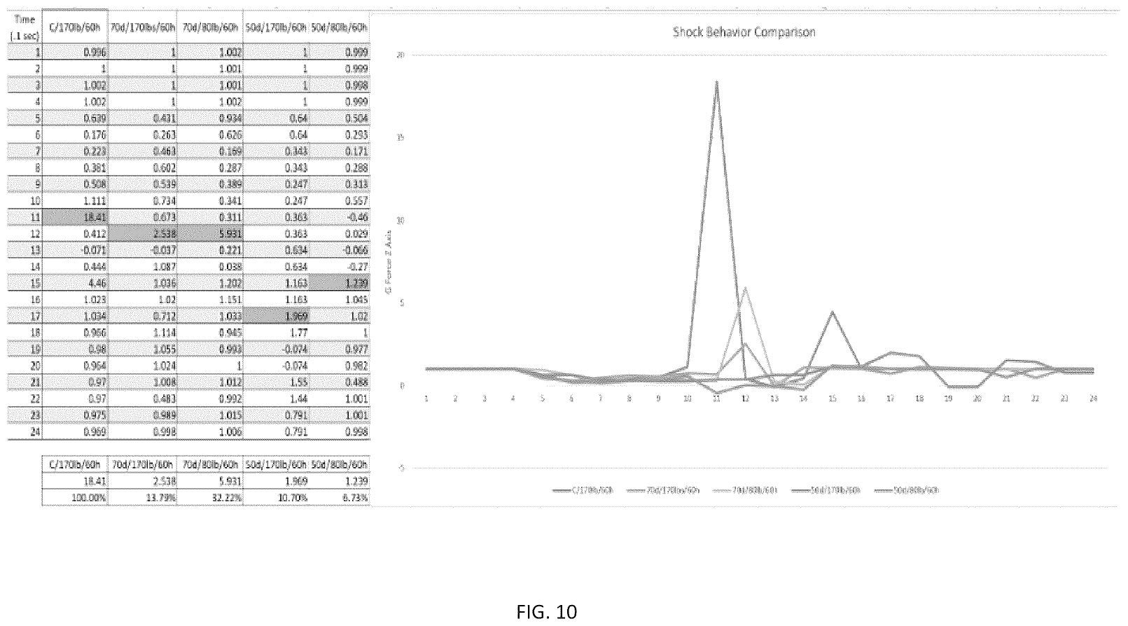

FIG. 10 depicts a comparison of the results of the drop test. Taking typical examples of each condition, the control drop of no isolators yielded 18.41 g's while the 50 Durometer yielded ˜90% less g-forces. See Table 2 below.

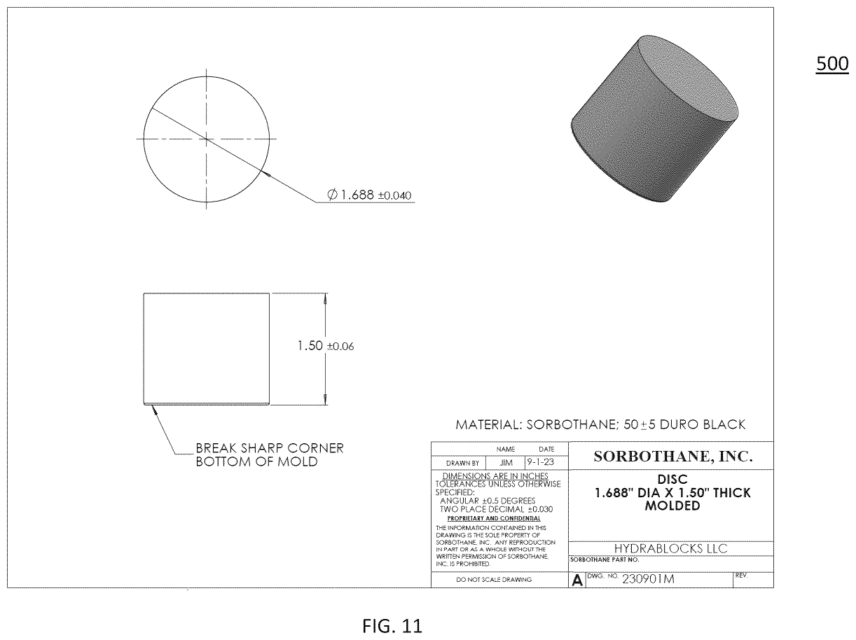

FIG. 11 depicts an exemplary sorbothane isolator 500 associated with a variable weightlifting platform system 102, in accordance with one or more embodiments of the present disclosure. In some embodiments, the final shape and mass of each isolator 500 of the arrangement of the plurality of sorbothane cylinders 410 was optimized for even greater performance. The final proposed isolator 500 designs are as follows:

| | | | Load Range | Load Range |
|---|---|---|---|---|
| | | | @10% | at 20% |
| | | Shape | deflection | deflection |
| Shape | Dimensions | Factor | (lbs.) | (lbs.) |
| 1.5″ Cube | L 1.5″ × W | .25 | 6.83 | 15.95 |
| | 1.5″ × H 1.5″ | | | |
| 1.5″ | DIA 1.5″ × H 1.5″ | .24 | 5.37 | 12.52 |
| Cylinder | | | | |
| 1.875″ | O-DIA 1.875″ × | 19 | 6.81 | 15.88 |
| Torus | I-DIA .725″ × H1.5″ | | | |
| 1.688″ | DIA 1.688″ × H 1.5″ | .28 | 7 | 16.33 |
| Cylinder | | | | |

All parts listed above has very good shape factors considering specification guidelines associated with sorbothane (all below. 3). The 1.5″ cube met all testing requirements. A cylinder of the same dimensions as the cube was considered, as it has slightly more non-loaded surface area than the cube. However, shape factor improvement was negligible, and performance was eroded due to less mass in the isolator. A torus was considered, due to maximum non-loaded surface area yielding the best shape factor. But it was determined that manufacturing the part is much more difficult, adding unnecessary cost. The final choice is a cylinder of slightly larger diameter to match the mass of the cube. It calculates a slightly poorer shape factor due to a higher load area but this variance is negligible. Most importantly, it had the best performing load ranges, which matched our needs to have maximum performance at all barbell masses.

Ultimately, the 50-durometer 1.688″dia. cylindrical shock mount was chosen (FIG. 8). Using these shock mounts achieved the best combination of deflection and dampening to ensure maximum system cycles before any maintenance.

### Hydrablock System

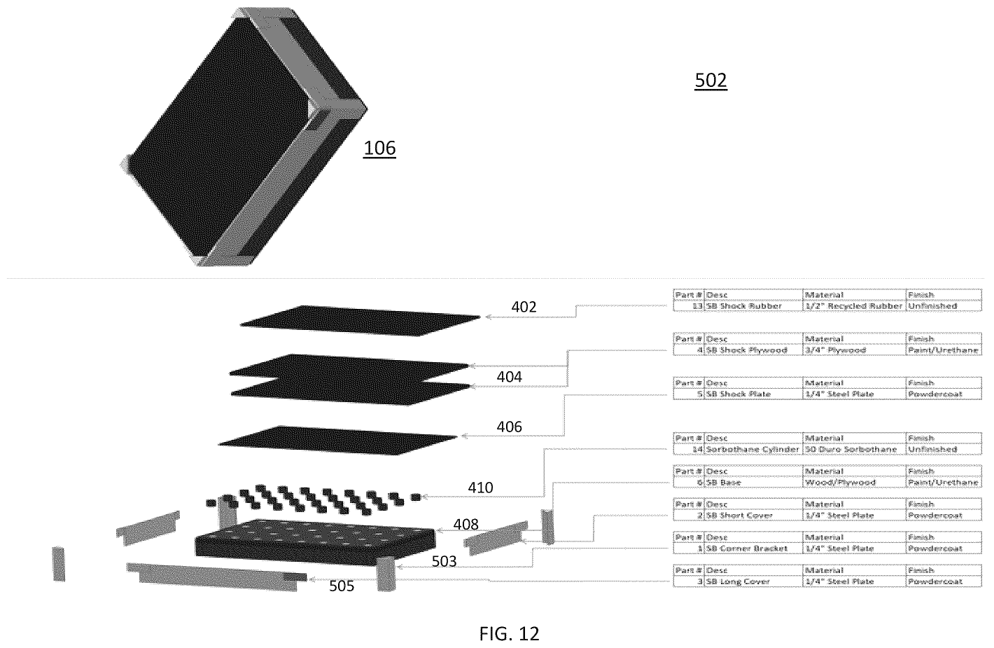

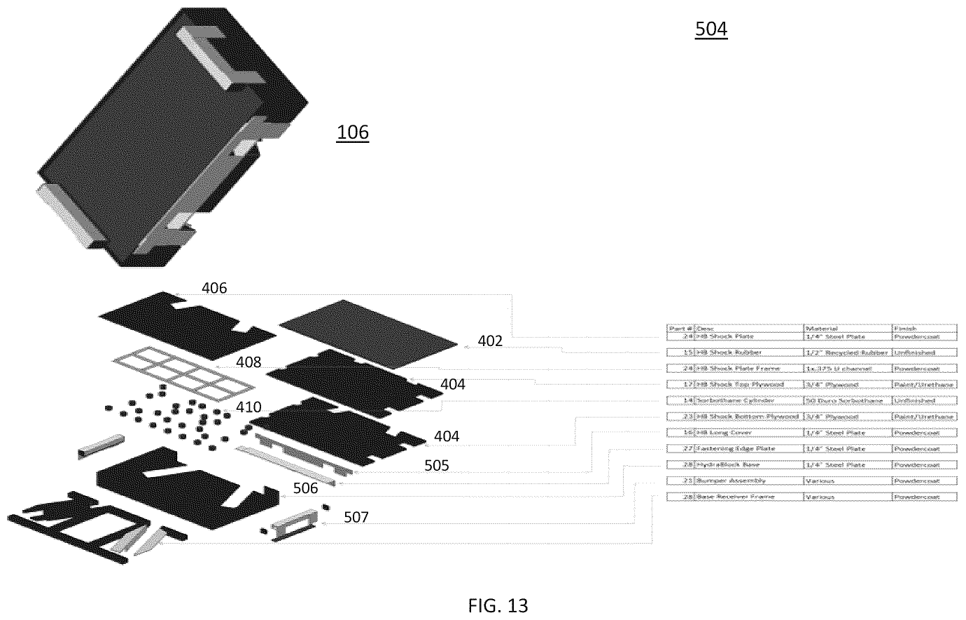

Looking at a cross section of a HydraBlock platform, there are 5 basic components to the shock system. (FIG. 12 and FIG. 13)

1. HB Shock Rubber: . 5″ of Recycled rubber is an optimal surface for abrasion resistance and a high coefficient of friction impact surface. However, this is the only purpose of the rubber. The material deforms over time due to excessive barbell impact in a commercial environment. Therefore, it was not considered for any other purpose than a high friction impact surface. The tangent impact surface area of weight plates is too small, while the force magnitude of the falling barbell is too large for only rubber to be used. The final result are permanent depressions on the material causing an unlevel lifting surface which is not safe in a commercial environment.

2. HB Shock Top and Bottom Plywood: 2×.75″ sheets of Urethane coated plywood reduce decibel level on impact. More importantly, it begins distribution of the impact force to the metal shock plate. This protects the Steel Shock Plate from deformation and ensures permanent integrity under any impact.

3. HB Shock Plate: The Steel Shock Plate distributes all forces equally to the Sorbothane shock mounts. This ensures the entire system remains level under impact which is critical for proper Sorbothane deflection. Too much deflection on any shock mount will erode durability of cycles.

4. HB Shock Plate Frame: The Shock Plate Frame protects the Shock Plate from deformation to ensure a permanently level system. This allows for maximum shock attenuation, and proper barbell rebound path ensuring user safety.

5. Sorbothane Cylinder: The Sorbothane Shock Mounts are engineered to absorb the entire range of forces possible during impacts regardless of platform height or barbell load (Oin-70 in, 35 lbs-1000 lbs). In addition, the combination of durometer, shape factor, and material mass, tune deflection to the proper displacement. This is critical for acquiring one million cycles of the Sorbothane, and thus shock system. Any other option is not practical in a commercial service setting due to material fatigue and maintenance.

### Real World Application Testing Comparisons

### Test 1

This first test is between the Platforms on the lowest height setting vs a normal gym rubber and concrete floor. The bar will always start at 9″ due to an 18″ weight plate diameter.

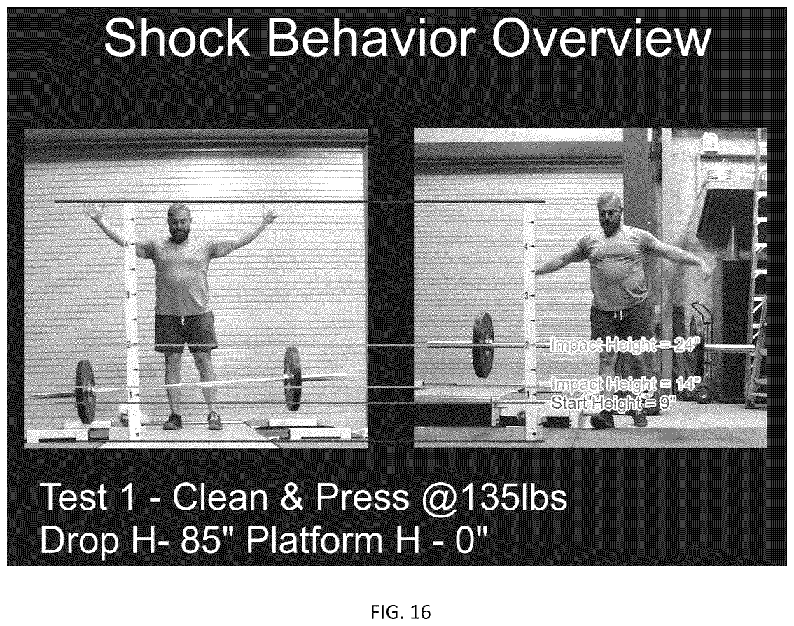

There is a 10-inch displacement difference reducing rebound energy by 66%. This can also be repeated indefinitely preventing damage to the facility floor or the user. (FIG. 16)

### TEST 2

This next test truly exploits the shock absorption HydraBlocks provides. A rack pull necessitates a higher start height, in this case 9″. This height plus a 9″ barbell plate diameter yields an 18″ start height.

Common Jerk Blocks are made from a pure plywood construction. They use vertical orientation for strength and then multiple sheets for impact resistance.

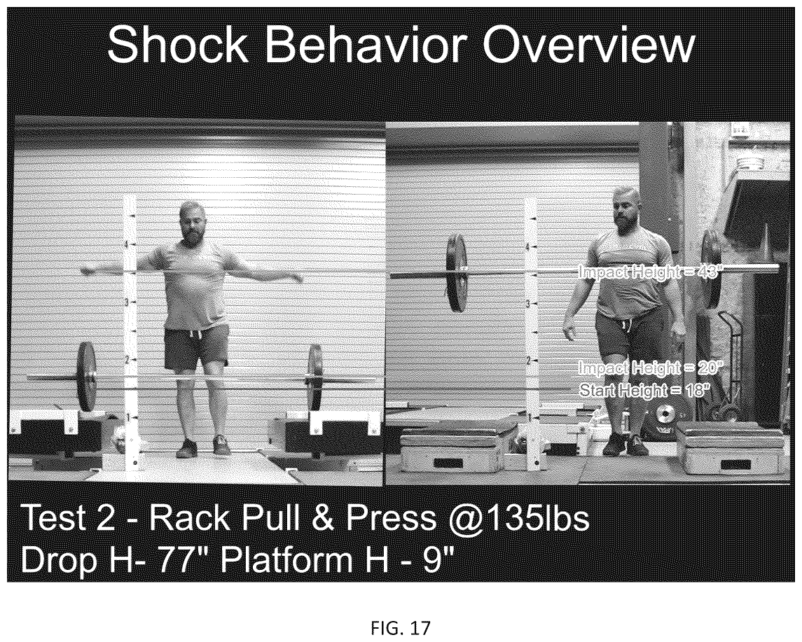

Although acceptable for use, the shock attenuation is far too low for a common commercial setting. HydraBlocks impresses with a 23-inch displacement reduction while absorbing 92.5% of the shock energy. (FIG. 17)

### Test 3

This test compares the highest loads typically used in weight lighting. This example shows two individuals performing rack pulls.

The individual on the left is using a squat rack equipped with safety straps. These are considered cutting edge in commercial settings vs traditional metal safety bars. They do solve two problems: impact noise is reduced and the barbell's knurling remains intact. However, they have very poor shock attenuation which transfers completely to the bar and user. This over time will bend bars leading to equipment damage. In addition, the straps will tear and degrade due to barbell knurling necessitating replacement.

This poor shock attenuation transfers to a more dangerous and less efficient experience for the lifter. Notice the time difference between the reps of both individuals. The lifter using the safety straps is exposed to tremendous oscillation of the barbell, forcing his body to control large random forces. This requires the lifter to wait for the energy to dissipate before performing another lift.

The HydraBlocks allow the lifter on the right to stay engaged with the lift increasing rep frequency. Energy is dissipated immediately eliminating unsafe random impact forces increasing safety. An increase in rep frequency increases power output of the lifter, exposing the lifter to greater stimulus, contributing to increased lifter performance and results.

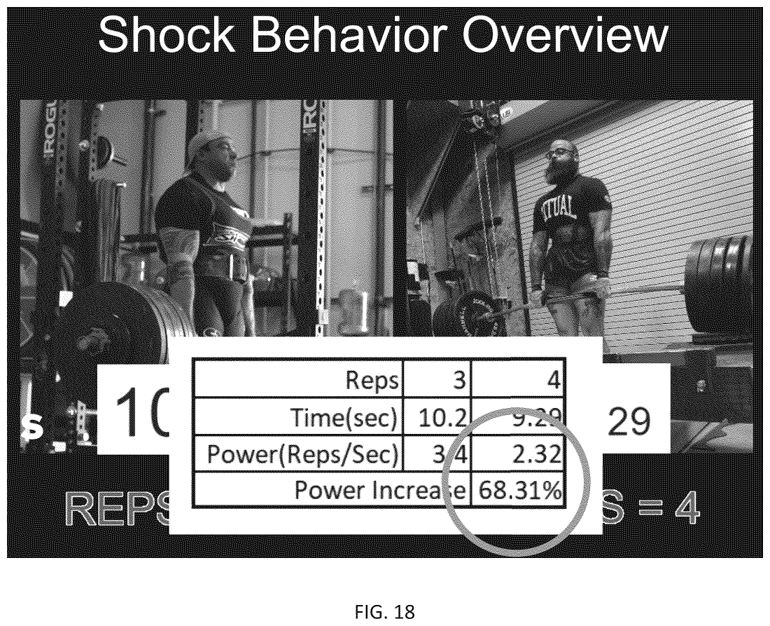

This example shows a 68% increase in power output when using HydraBlocks. (FIG. 18) Multi-Portion Platform

The hydraulic platform system 102, in various embodiments, may include a platform 104 and one or more hydraulic lifts 108. The platform may include a plurality of static portions and one or more elevating portions 106 (sometimes referred to herein as weight supports). In certain embodiments, the plurality of static portions may include a central static portion, where a user can stand. The one or more elevating portions 106 may be located on opposite sides of the central static portion and, in some embodiments, may provide support to the plurality of weights by balancing the plurality of weights when placed at an end of a barbell. In certain embodiments, the one or more elevating portions 106 may be raised and/or lowered using the hydraulic lift 108. The one or more elevating portions 106 may raise the plurality of weights to a desired height using the hydraulic lift 108. Such height, in various embodiments, may refer to a minimum height of one inch over the static platforms and a maximum height of 100 inches over the static portions and in a preferred embodiment, the one or more elevating portions 106 may raise the plurality of weights to a preferred height of sixty-six inches above the static platforms. While the platform system 102 may be described herein as including the full platform, it should be recognized that in some embodiments the platform may be omitted such that the system 102 includes only the hydraulic lifts 108 and elevating portions 106.

In certain embodiments, the hydraulic platform system 102 may include two variable height shock platforms 202 and four stationary shock platforms 204. In some embodiments, each portion of the plurality of portions may maintain an overall dimension of a height of sixteen inches, width of sixteen inches, and a length of sixteen inches (e.g., sixteen inches cubed). In certain embodiments, each portion may maintain a preferred overall dimension of twelve inches cubed.

### Hydraulic Lift

In some embodiments, the hydraulic platform system 102 may utilize one or more direct drive hydraulic cylinders 108 to raise and/or lower the one or more elevating portions 106. The one or more direct drive hydraulic cylinders 108 may automatically raise and/or lower the one or more elevating portions 106 via a control module (not shown). In certain embodiments, the control module may refer to a remote control device capable of instructing the one or more direct drive hydraulic cylinders 108 to raise and/or lower the one or more elevating portions 106. In some embodiments, the use of the direct drive hydraulic cylinders 108 within the hydraulic platform system 102 provides additional safety features to the user via eliminating shear points, such as scissor arms or levers. In some embodiments, the hydraulic platform system 102 provides additional safety features to the user via an automatic mechanical rachet safety system. In some embodiments, the one or more direct drive hydraulic cylinders 108 of the hydraulic platform system 102 may require a shock attenuation system 401 to mitigate shock at particular heights. In certain embodiments, the shock attenuation system 401 may refer to a shock mitigation system. This shock mitigation system in conjunction with the direct drive hydraulic cylinders 108 may allow the hydraulic platform system 102 to provide a non-incremental height system.

### Shock Attenuation

Elevating portions of the system, in various embodiments, may be constructed with shock absorbing materials. As configured, a user may drop the barbell onto the elevating portions 106 without the barbell bouncing significantly. This improves safety, as there is a reduced risk of the barbell falling from an elevated position, and also reduce the chances of the barbell becoming bent, which is typically a result of repeated drops on a standard floor, squat rack, or traditional jerk blocks. In some embodiments, other sections of the platform 104 (e.g., the aforementioned static sections) may be constructed with shock absorbing materials as well, since a user may opt to drop the barbell to the platform 104 rather than set it back on the elevating portions 106.

As later described in more detail, in some embodiments, the shock absorbing materials include a collection of sorbothane members that form a layer capable of absorbing any energy of dropping mass on the weight supports forming the arrangement of the plurality of sorbothane cylinders 410. The sorbothane members may be shaped to maximize their surface area to improve shock absorbing performance e.g., a disk shape as opposed to a cube shape. In some embodiments, the arrangement of the plurality of sorbothane cylinders 410 may be arranged side by side, with as many as 32 particular sorbothane cylinders included in a single elevating weight support in one particular embodiment. Other layers of the shock absorbing material may sandwich the layer of the plurality of sorbothane cylinders 410, and may be made of materials like wood, steel plates, and/or rubber.

In some embodiments, the hydraulic platform system 102 utilizes a shock attenuation system 401 that mitigate shock energy within the system by at least 90% of the force associated with the plurality of weights. In some embodiments, the shock attenuation system 401 may eliminate barbell rebound, which further improves user safety as the shock attenuation system 401 may prevent random barbell impact via the elimination of barbell rebound. In some embodiments, the hydraulic platform system 102 may utilize the shock attenuation system 401 for additional protection to the hydraulic platform system 102, where the shock attenuation system 401 may prolong the lifespan of the hydraulic platform system 102 by removing the at least 90% of the force associated with the plurality of weights.

In some embodiments, the shock attenuation system 401 may mitigate the shock energy within the system by up to 99% of the force associated with the plurality of weights. In certain embodiments, the shock attenuation system 401 may preferably mitigate the shock energy within the system by at least 92.5%. In some embodiments, the shock attenuation system 401 may utilize a particular isolator to obtain the mitigation of shock energy within the hydraulic platform system 102. In certain embodiments, the particular isolator may refer to a sorbothane material. In some embodiments, the shock attenuation system 401 may utilize the particular isolator to mitigate impact variance, where the mitigation of impact variance allows the user to continually lift the plurality of weights without a need to reindex posture (i.e., rack the weight and adjust posture of user). For example, the shock attenuation system 401 may mitigate the shock in a way as to provide the user with a feeling that the weights are situated within a track.

In some embodiments, the particular isolator within the shock attenuation system 401 may mitigate the impact variance in proportion to a calculated shape factor. In certain embodiments, the shape factor may refer to a ration of a load area to an unloaded area of the particular isolator. In some embodiments, the particular isolator may maintain a shape factor between a minimum limit of 0.1 static deflection and a maximum limit of 1.5 static deflection, with a range of five percent to thirty percent of fatigue life. In certain embodiments, a shape factor less than 1.2 and less than forty percent expected fatigue life may be predicted to perform in excess of a million cycles, where a shape factor less than 1.2 and an expected fatigue life between forty percent and sixty percent may be predicted to perform an excess of 1,000 cycles. To obtain a configuration of the particular isolator within the shock attenuation system, a level impact surface under static and dynamic forces via a range of twenty to fifty individual isolators arranged in a configuration. In certain embodiments, the shock attenuation system 401 may utilize at least thirty-two individual isolators arranged in a four by eight configuration.

In some embodiments, the shock attenuation system 401 may mitigate impact g-force and impact deflection by at least. 25 inches, which is roughly 16.67% of the impact deflection and at most. 5 inches, which is roughly 34% of the impact deflection.

TABLE 1
50-Durometer Deflection

| | | Displacement | Isolator | Height |
|---|---|---|---|---|
| Status | Displacement | % | Height | % |
| No Load | 0″ | 0 | 1.5″ | 0 |
| Top Plate Added | 0.25″ | 16.67% | 1.25″ | 83.33% |
| Max Impact | 0.5″ | 33.33% | 1″ | 66.67% |
| Total Deflection | 0.75″ | 50.00% | 0.75″ | 50.00% |

Table 1 provides additional detail on the impact mitigation of the shock attenuation system, specifically the impact displacement based on the use of the isolator configuration as previously described.

TABLE 2

| Condition | C/170/60 | | 70/170/60 | | 70/80/60 | | 50/170/60 | | 50/80/60 | |
|---|---|---|---|---|---|---|---|---|---|---|
| g-force | 18.41 | g | 2.538 | g | 5.931 | g | 1.969 | g | 1.239 | g |
| Percent | 100.00% | | 13.79% | | 32.22% | | 10.70% | | 6.73% | |
| Compare | | | | | | | | | | |
| Group | ~18 | g | ~2.5 | g | ~5.7 | g | ~2 | g | ~<2 | g |
| Average | | | | | | | | | | |

Table 2 provides additional information related to the impact g-forces associated with the shock attenuation system of each condition, where the control drop of no isolators yielded 18.41 g's while the 50 Durometer yielded ˜90% less g-forces. Each variation of these factors may be depicted in FIG. 5-FIG. 9.

TABLE 3

| | | | Load Range | Load Range |
|---|---|---|---|---|
| | | | @10% | at 20% |
| | | Shape | deflection | deflection |
| Shape | Dimensions | Factor | (lbs.) | (lbs.) |
| 1.5″ Cube | L 1.5″ × W | .25 | 6.83 | 15.95 |
| | 1.5″ × H 1.5″ | | | |
| 1.5″ | DIA 1.5″ × H 1.5″ | .24 | 5.37 | 12.52 |
| Cylinder | | | | |
| 1.875″ | O-DIA 1.875″ × | 19 | 6.81 | 15.88 |
| Torus | I-DIA .725″ × H1.5″ | | | |
| 1.688″ | DIA 1.688″ × H 1.5″ | .28 | 7 | 16.33 |
| Cylinder | | | | |

Table 3 provides additional information associated with an individual shape of the particular isolator within the shock attenuation system 401, where a final shape and mass of the isolator was optimized for even greater performance. In certain embodiments, the 1.5″ cube shape of the particular isolator met all testing requirements, and a cylinder of the same dimensions as the cube was considered, as it may have a slightly more non-loaded surface area than the cube. However, shape factor improvement may be negligible and performance may be eroded due to less mass in the isolator. In certain embodiments, a torus shape may be considered, due to maximum non-loaded surface area yielding the shape factor. In some embodiments, a cylinder of slightly larger diameter to match the mass of the cube may be utilized as the particular isolator within the shock attenuation system. In certain embodiments, the cylinder of slightly larger diameter performed in the ideal load ranges, which matched a maximum performance at all barbell masses. In some embodiments and in response to using the larger cylinder isolators, the shock attenuation system may achieve deflection and dampening to ensure maximum system cycles before any maintenance.

Referring to FIGS. 12 and 13, an exploded view 502 and 504, respectively, of the elevating platform 106 may include a shock rubber 402, an upper and lower levels of plywood 404, a shock plate 406, a shock plate frame 408, and a particular isolator 410 of a plurality of sorbothane cylinders. In some embodiments, a plurality of corner brackets 503 may be affixed to each corner of the shock plate frame 408, while one or more cover panels 505 may cover the sided of the shock plate frame 408, where the plurality of corner brackets 503 and the one or more cover panels 505 may be made of steel. In some embodiments, a base 506 made of steel may be placed under the elevating platform 106. In some embodiments, additional bumpers 507 may be affixed to each distal end of the elevating platform 106 and may be made of any material able to withstand the impact of the barbell forces. In some embodiments, the shock rubber 402 may consist of 0.5 inches of recycled rubber. In certain embodiments, the shock rubber 402 may provide abrasion resistant and a high coefficient of friction impact surface. In some embodiments, the shock rubber 402 may be modified with a material to prevent shape deformity and depressions, which maintain the user safety as the shock rubber 402 remains level. In some embodiments, the upper and lower levels of plywood 404 may refer to a top shock plywood and a bottom shock plywood, where each layer of shock plywood may refer to a 75-inch sheet of urethane-coated plywood material. In certain embodiments, the shock plywood may assist the hydraulic platform system 102 distribute the impact force to the shock plate 406 and protect the shock plate 406 from deformation under impact. In some embodiments, the shock plate 406 may refer to a steel shock plate that assists the hydraulic platform system 102 equally distribute the impact forces to the shock plate frame 408 and the individual isolator 410. In certain embodiments, the shock plate 406 may ensure the hydraulic platform system 102 remains level under impact while limiting the impact deflection on the shock plate frame 408. In some embodiments, the shock plate frame 408 may assist the hydraulic platform system 102 in remaining level by protecting the shock plate 406 from deformation. In certain embodiments, the shock plate frame 408 may allow for maximum shock attenuation and proper weight rebound path to ensure for user safety. In some embodiments, the particular isolator 410 may absorb a range of impact forces regardless of platform height or barbell load (e.g., Oin-70 in, 35 lbs-1000 lbs, respectively). In some embodiments, the particular isolator 410 may maintain consistent shape factor, material mass, and impact deflection to a predictable displacement, which is critical to exceed one million cycles of performance of the hydraulic platform system 102, and thus the shock attenuation system 401.

### Test Data

A first test was performed between the hydraulic platform system 102 on the lowest height setting vs a normal gym rubber and concrete floor. The bar will always start at 9″ due to an 18″ weight plate diameter There is a 10-inch displacement difference reducing rebound energy by 66%. This can also be repeated indefinitely preventing damage to the facility floor or the user. A second test was performed to depict the shock absorption the hydraulic platform system 102 provides. A rack pull necessitates a higher start height, in this case 9″. This height plus a 9″ barbell plate diameter yields an 18″ start height. In this test, the hydraulic platform system 102 provides a 23-inch displacement reduction while absorbing 92.5% of the shock energy. A third test compares the highest loads typically used in weight lighting. This example shows two individuals performing rack pulls. A first individual uses a squat rack equipped with safety straps. The modified squat rack provides reduction in impact noise and maintains the knurling of the barbell. However, these modified squat racks have very poor shock attenuation which transfers completely to the barbell and user. This over time will bend bars leading to equipment damage. In addition, the straps will tear and degrade due to barbell knurling necessitating replacement. This poor shock attenuation transfers to a more dangerous and less efficient experience for the lifter. In certain embodiments, the first individual using the safety straps may be exposed to oscillation of the barbell, forcing his body to control large random forces. This requires the first individual to wait for the energy to dissipate before performing another lift, as previously described as user index. In contrast, the hydraulic platform system 102 allows a second individual to stay engaged with the lift increasing rep frequency. Energy is dissipated immediately eliminating unsafe random impact forces increasing safety. An increase in rep frequency increases power output of the second individual, exposing the lifter to greater stimulus, contributing to increased lifter performance and results. In some embodiments, the hydraulic platform system 102 may provide a 68% increase in power output.

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

What is claimed is:

1. A weightlifting system, comprising:
first and second elevating platforms, each being configured to support first and second opposing ends of a barbell, respectively; and
first and second hydraulic mechanisms coupled to the first and second elevating platforms, respectively, and configured to move the elevating platforms in a vertical direction between a first position and a second position to raise and lower the barbell,
wherein each of the first and second elevating platforms comprises:
a shock rubber layer,
one or more plywood layers positioned below the shock rubber layer,
a shock plate positioned below the one or more plywood layers, the shock plate configured to distribute, equally to a plurality of energy attenuating isolators arranged below the shock plate, forces applied to the elevating platform when contacted by the barbell, and
a shock plate frame positioned between the shock plate and the plurality of isolators, the shock plate frame configured to support and prevent deformation of the shock plate.

2. The system of claim 1, further comprising a static platform positioned between the first and second elevating platforms and configured to support a user of the barbell.

3. The system of claim 1, wherein the shock rubber layer comprises a recycled rubber material having an upper surface that is sufficiently abrasion resistant to withstand impacts from the barbell and a high coefficient of friction for deterring movement of the barbell on the upper surface.

4. The system of claim 1, wherein the one or more plywood layers comprise an upper layer and a lower level of urethane-coated plywood material.

5. The system of claim 1, wherein the shock plate is made of a metal material.

6. The system of claim 1, wherein at least one of the plurality of energy attenuating isolators comprises a sorbothane material.

7. The system of claim 6, wherein the at least one energy attenuating isolator comprising the sorbothane material has a cylindrical shape.

8. The system of claim 7, wherein the at least one energy attenuating isolator comprising the sorbothane material is configured to maintain a consistent shape factor, material mass, and predictable displacement in response to an impact of the barbell with the elevating platforms, wherein the barbell weighs between about 35 pounds and about 1000 pounds and is dropped from heights ranging between about 0 inches above the elevating platforms to about 80 inches above the elevating platforms.

9. The system of claim 8, wherein the at least one energy attenuating isolator comprising the sorbothane material has a hardness of about 70 duro, and wherein the elevating platforms attenuate energy associated with the impact to maximum gravitational forces equivalent of about 2.5 Gs and about 6 Gs for impacts consistent with a mass being dropped from about 60 inches and weighing about 170 pounds and about 80 pounds, respectively.

10. The system of claim 8, wherein the at least one energy attenuating isolator comprising the sorbothane material has a hardness of about 50 duro, and wherein the elevating platforms attenuate energy associated with the impact to maximum gravitational forces equivalent of about 2 Gs and about 1.2 Gs for impacts consistent with a mass being dropped from about 60 inches and weighing about 170 pounds and about 80 pounds, respectively.

11. The system of claim 1, wherein the first and second hydraulic mechanisms each comprise one or more direct drive hydraulic cylinders capable of automatically raising or lowering the elevating platforms between the first position and the second position.

12. The system of claim 1, wherein the first position is even with a surface on which a user is supported when using the system and the second position is above the first position.

13. An energy attenuating system, comprising:
a first layer comprising recycled rubber having a thickness of about 0.5 inches;
a second layer and a third layer, each comprising plywood having a thickness of about 0.75 inches;
a fourth layer comprising a steel plate having a thickness of about 0.25 inches; and
a fifth layer comprising a plurality of deformable members, each deformable member comprising a sorbothane material.

14. The system of claim 13, wherein the first layer has a thickness of about 0.5 inches.

15. The system of claim 13, wherein the second and third layers each have a thickness of about 0.75 inches.

16. The system of claim 13, wherein the fourth layer has a thickness of about 0.25 inches.

17. The system of claim 13, wherein the plurality of deformable members have a hardness of between about 50 duro and 70 duro.

18. The system of claim 13, wherein the plurality of deformable members have a shape factor of between about 0.3 and about 1.0.

19. The system of claim 13, wherein the plurality of deformable members have a cylindrical shape with a diameter of about 1.5 inches to about 1.7 inches, and a height of about 1.5 inches.

20. A weightlifting system, comprising:
a platform, comprising:
first and second elevating platform portions, each being configured to support first and second opposing ends of a barbell, respectively;
one or more static platform portions, at least one of which is positioned between the first and second elevating platform portions and configured to support a user of the barbell; and
first and second hydraulic mechanisms coupled to the first and second elevating platform portions, respectively, and configured to move the elevating platform portions in a vertical direction between a first position substantially even with, and a second position above, the at least one static portion positioned between the first and second elevating platform sections to raise and lower the barbell.
